(19) United States
(12) Patent Application Publication
(10) Pub. No.: US 2003/0189117 A1
(43) Pub. Date: Oct. 9, 2003

(54) Refining segment for a rotatable refining disc, and a refining apparatus comprising a refining disc with such refining segment

(76) Inventor: Nils Virving, Hasselby (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/297,516

(22) PCT Filed: Jun. 7, 2001
(86) PCT No.: PCT/SE01/01282

(30) Foreign Application Priority Data
Jun. 8, 2000 (SE) 0002154-3

(51) Int. Cl. B02C 1/10

(52) U.S. Cl. 241/296

(57) ABSTRACT

The present invention relates to a refining segment (7; 17; 27; 37) for a rotatable refining disc included in refining apparatus, for disintegrating and refining material containing lignocellulose in a refining gap between two opposing refining discs (4, 5) rotatable in relation to each other. It is characterized in that it is provided with at least one cleaning member (10; 20; 30; 40) for clearing away material that has collected outside the outer edge of the refining disc. The invention also relates to refining apparatus provided with at least one such refining segment.

The present invention relates to a refining segment constituting at least part of a rotatable refining disc included in refining apparatus for disintegrating and refining material containing lignocellulose in a refining gap between two opposing refining discs rotatable in relation to each other. The invention also relates to refining apparatus comprising a refining disc that includes one or more such refining segments.

Refining apparatus or disc refiners of this type are used, for instance, for highly concentrated refining, CTMP, TMP, fluffing and highly concentrated grinding of sack paper and other fibrous material containing lignocellulose. They usually comprise a rotatable refining disc, mounted on a rotor, and a non-rotatable refining disc, mounted on a stator. Refining discs in this type of refining apparatus are built up of refining segments that form refining surfaces. The refining segments are replaced at regular intervals due to considerable wear. They are either mounted directly on the rotor and stator, respectively, or by means of special segment holders. A refining disc may consist of one or more annular refining segments or of several divided, radial refining segments. Refining segments may be in the form of central segments and peripheral segments, the peripheral segments being located outermost along the periphery, and the central segments being located inside the peripheral segments. Between the refining disc/surfaces on the rotor and stator, respectively, is a space in the form of a refining gap.

A serious problem with this type of refining apparatus, particularly when the apparatus is started, is that fibre often builds up to a cake of pulp between the rotatable parts and the surrounding refiner housing. This cake of pulp sometimes tends to become lodged and completely block transport of fibres to the outlet. Besides this obvious drawback, the build-up of pulp in the refiner housing also results in high friction along the periphery of the rotatable parts, due to the high rate of rotation, and also considerable generation of heat which may cause the fibres to carbonise, becoming so hard that the rotor is turned as by a lathe, and may cause breakdown. Even if things do not reach this stage, the build-up of pulp causes continuous wear on the outer part of the rotor and the segment holders of the refining disc when used, so that they may break down in the end. The heat generation may also be so high that the rotor and/or the segment holder may melt. According to conventional technology attempts to eliminate these problems entail providing the rotor itself with wings that protrude into the space between the rotor and the outer wall of the refiner housing to keep it clean. However, these wings often give rise to cavitation damage in the attachment between wing and rotor, which may lead to the wing gradually becoming dislodged, with disastrous consequences. To avoid this, regular maintenance must be undertaken, which is naturally associated with costs.

The object of the present invention is to remedy the problems mentioned above. This is achieved by making use of a refining segment provided with at least one cleaning member for clearing away material that has collected outside the outer edge of the refining disc. Thus, in accordance with the invention, the refining segment is provided with a cleaning member instead of the actual rotor being provided with a cleaning member in the form of a wing. As mentioned above, the refining segment on the rotor is replaced at regular intervals and the cleaning member joined to the refining segment is thus also replaced long before any risk of serious damage arises.

In accordance with a preferred feature the cleaning member is made in one piece with the refining segment, preferably by means of casting.

The invention has the advantage of being applicable to refining apparatus both of the “single disc” type with a rotatable refining disc and a stationary refining disc, and of the “double disc” type with two refining disc rotating against each other.

In accordance with the present invention is also provided a refining apparatus provided with a refining disc having such refining segments.

Further advantages and characteristics are revealed in the remaining sub-claims.

The invention will now be described with reference to the accompanying drawings, illustrating embodiments of the invention by way of example, in which

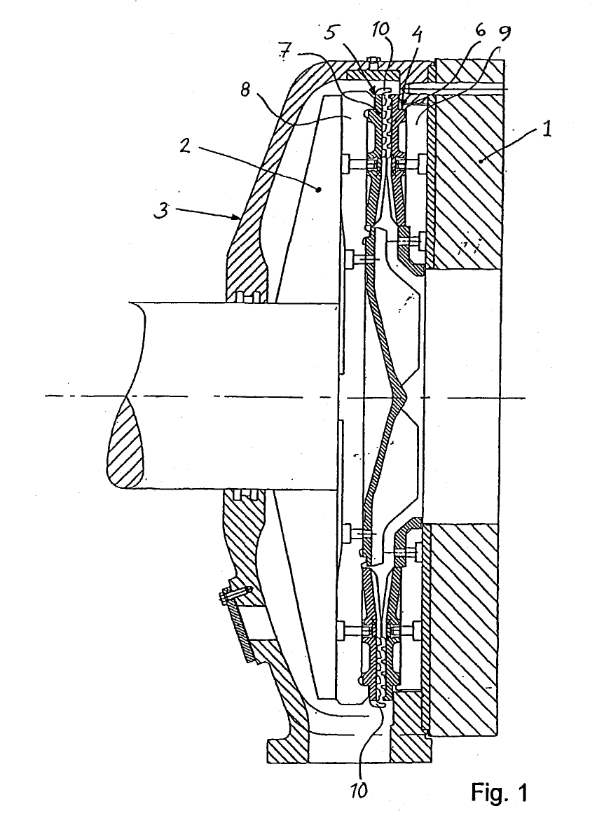

FIG. 1 shows a side view, in cross section, of a disc refiner in accordance with the present invention,

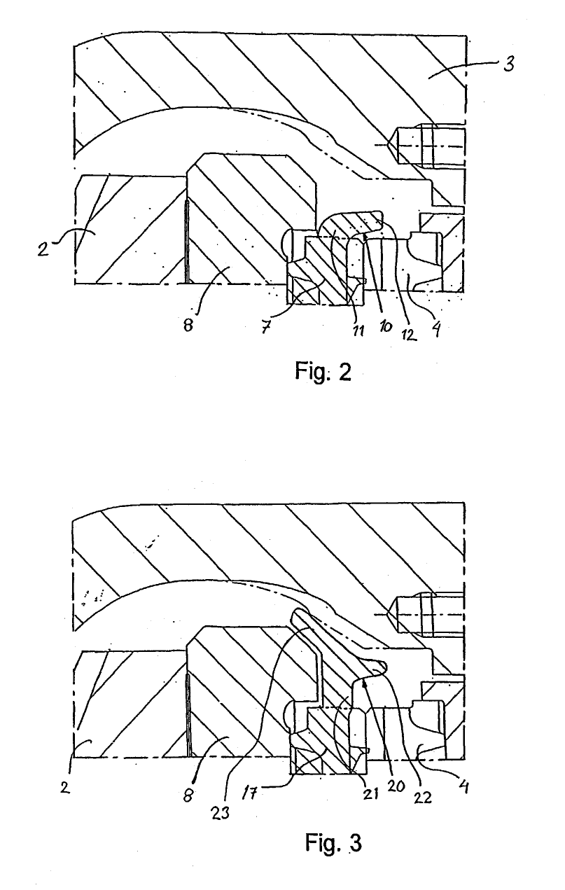

FIG. 2 shows a partial view, in cross section and enlarged, of a disc refiner having a refining segment in accordance with a first embodiment of the present invention,

FIG. 3 is a partial view corresponding to FIG. 2, but illustrating a second embodiment of a refining segment in accordance with the present invention,

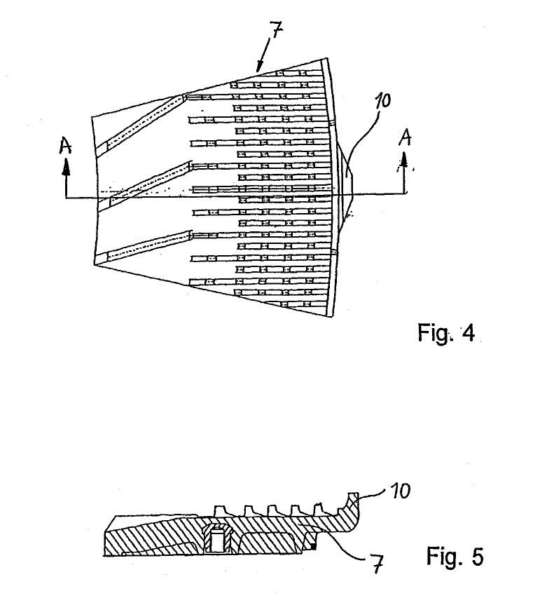

FIG. 4 is a view from above of a refining segment in accordance with the present invention, in accordance with the first embodiment shown in FIG. 2,

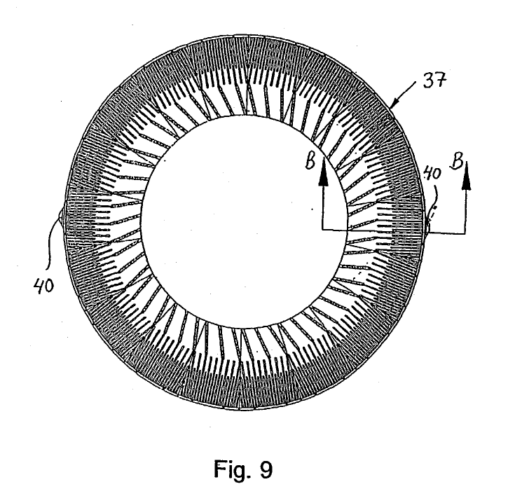

FIG. 5 is a view in cross section of the refining segment in FIG. 4, taken along the line A-A, or alternatively the refining segment in FIG. 9 below, taken along the line B-B,

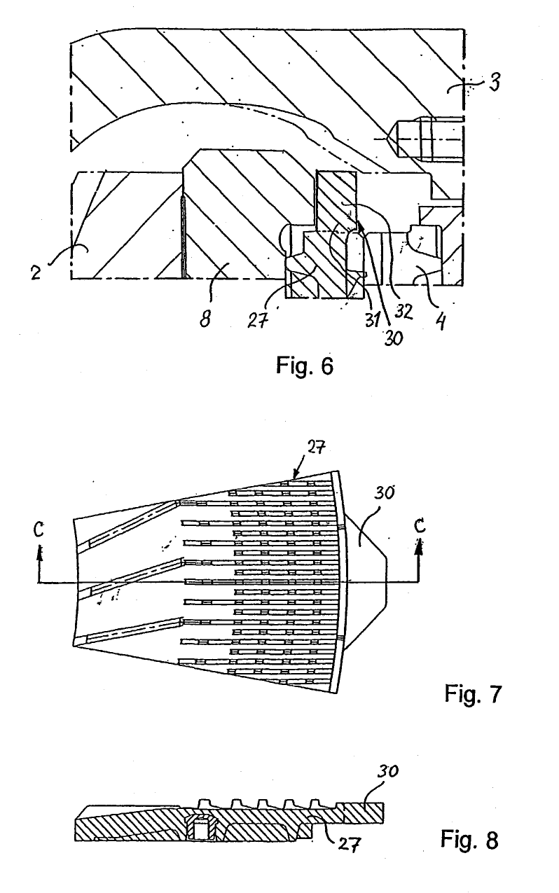

FIG. 6 is a partial view corresponding to FIGS. 2 and 3, but illustrating a third embodiment of a refining segment in accordance with the present invention,

FIG. 7 is a view from above of a refining segment in accordance with the present invention, in accordance with the third embodiment shown in FIG. 6,

FIG. 8 is a view in cross section of the refining segment in FIG. 7, taken along the line C-C, and

FIG. 9 shows a view from above of a variant of a refining segment in accordance with the present invention.

FIG. 1 illustrates a disc refiner comprising a stationary part, stator 1, and a rotatable part, rotor 2, arranged in a refiner housing 3. Refining discs 4, 5 are mounted on stator and rotor, respectively. These refining discs are generally divided into segments, known as refining segments or stator segments 6 and rotor segments 7, respectively, forming refining surfaces. The refining segments are normally pre-fitted on segment holders 8, 9, respectively, in order to enable quick exchanging, but may also be fitted directly on the rotor or the stator. The number of segments may vary, as mentioned above. A rotor refining disc generally has eight, twelve or eighteen segments. Whole, i.e. undivided, refining discs are also possible, particularly in small refineries. The stator usually has refining segments corresponding to those of the rotor.

A refining gap is produced between the refining surfaces, where the material fed in is refined.

FIG. 2 illustrates a first embodiment of a refining segment in accordance with the present invention. This refining segment 7 is mounted on a segment holder 8 pertaining to a rotor 2 in the refining apparatus. The refining segment is provided at its periphery with a cleaning member 10 in the form of a “wing” to prevent and remove the pulp cake that would otherwise be formed between the rotating parts and the refiner housing. This cleaning member 10 or wing may be said to comprise a first radial holder part 11 and a second part 12 arranged at the outer end of the first part 11 and constituting the true cleaning element which is angled to the direction of rotation, preferably in a non-radial plane. Its angle in relation to the direction of rotation is preferably about 90°, and its angle in relation to the radial direction is also preferably about 90°, as illustrated in FIG. 2. Alternative, it may be described as forming an angle in the order of 90° in relation to the refining surface. In accordance with this embodiment, thus, the cleaning element 12 is angled towards the opposing refining disc. It may naturally be angled so that it is parallel with the direction of the axis of rotation, but it may also have an angle in relation to the direction of the axis of rotation. The cleaning member is preferably streamlined in order to reduce turbulence and thereby avoid cavitation. It may, for instance, have a rounded forward edge, possibly on both sides so that it is reversible. This can be seen most clearly in FIGS. 4 and 5.

FIG. 3 illustrates a second embodiment of a refining segment in accordance with the present invention. This refining segment 17 is provided with a wing or cleaning member 20, here provided with a holder part 21 and two protruding portions 22, 23 forming cleaning elements. One portion 23 protrudes substantially rearwards in a direction along the periphery of the refining disc on which the cleaning member is arranged and the other portion 22 protrudes substantially forwards in a direction along the periphery of the opposing refining disc.

FIGS. 4 and 5 illustrate in more detail a refining segment 7 in accordance with the first embodiment of the present invention, provided with a wing-shaped cleaning member 10. A “divided” refining segment or radial refining segment is seen here, designed to be placed along the periphery of the refining disc and which, together with a number of other segments, forms the refining disc. A radial refining segment might naturally also have cleaning members designed in accordance with the second embodiment.

FIG. 6 shows schematically a third embodiment of a refining segment 27 in accordance with the present invention, in a view analogous with FIGS. 2 and 3. This refining segment is shown in detail in a view from above in FIG. 7 and a cross sectional view in FIG. 8. In accordance with this third embodiment the refining segment is provided with a cleaning member 30 comprising a holder part 31 and a cleaning element 32 which here protrudes in radial direction, i.e. it is not angled in relation to the refining surfaces.

The number of refining segments having the specially designed cleaning member in accordance with the present invention may vary. In the case of radial segments it is possible to have only one segment with a cleaning member along the periphery of the refining disc, the remaining refining segments then being of standard type without cleaning members. However, to achieve good balance it may be preferable to have two refining segments with cleaning members arranged diametrically opposite each other. It is also possible to have four segments or more with cleaning members, and the remainder without.

FIG. 9 illustrates a corresponding refining segment 37 which is annular. In this case the refining segment is provided with two diametrically opposed cleaning members 40, designed in accordance with the first embodiment shown in FIGS. 1 and 2. A cross section of this refining segment is as illustrated in FIG. 5. Naturally, here also, the cleaning member might be designed as shown in FIG. 3 or in FIG. 6.

When the refining segment is annular in shape it is also possible to have only one cleaning member. However, from the balance aspect at least two cleaning members are preferred.

The present invention shall not be deemed limited to the embodiments described here by way of example, but can be varied and modified in many ways, as will be realised by one skilled in the relevant technical area, within the scope of what is defined in the appended claims.

1. A refining segment (7; 17; 27; 37) intended to constitute at least a part of a refining surface of a rotatable refining disc included In a refining apparatus for disintegrating and refining material containing lignocellulose in a refining gap between two opposing refining discs (4, 5) rotatable in relation to each other, and which segment Is a wear detail that is replaced at regular intervals characterized in that it is provided with at least one cleaning member (10; 20; 30; 40) arranged to prodrude from the periphery of the refining segment in a space between the outer edge of the refining segment and the inside of the refiner housing (3) in which the refining discs (4, 5) are arranged, for clearing away material that has collected outside the outer edge of the refining disc.

2. A refining segment as claimed in claim 1, characterized in that the cleaning member (10; 20; 40) comprises a first part (11; 21) protruding substantially radially from the periphery of the refining segment and extending past the outer edge of the rotating refining disc, and a second part (12; 22, 23) arranged at the outer end of the first part, angled in relation to the direction of rotation and in relation to said first part (11; 21).

3. A refining segment as claimed in claim 2, characterized in that the second part (12; 22, 23) is shaped to extend, at least partially, substantially parallel to the direction of the axis of rotation of the refining disc.

4. A refining segment as claimed in any one of claims 2-3, characterized in that the second part has a portion (12; 22) protruding substantially forwards in a direction along the periphery of the opposing refining disc.

5. A refining segment as claimed in any one of claims 2-4, characterized in that the second part has a portion (23) protruding substantially rearwards in a direction along the periphery of the refining disc on which the cleaning member is arranged.

6. A refining segment as claimed in claim 1, characterized in that the cleaning member (30) comprises a first part (31) protruding substantially radially from the periphery of the refining segment and extending past the outer edge of the rotating refining disc, and a second part (32) arranged at the outer end of the first part (31) and this also protruding substantially in radial direction.

7. A refining segment as claimed in any one of claims 1-6, characterized in that the cleaning member (10; 20; 30; 40) is streamlined.

8. A refining segment as claimed in any one of claims 1-7, characterized in that the cleaning member (10; 20; 30; 40) is a separate part that is attached to the refining segment.

9. A refining segment as claimed in any one of claims 1-7, characterized in that the cleaning member (10; 20; 30; 40) is made in one piece with the refining segment.

10. A refining segment as claimed in any one of claims 1-9, characterized in that the refining segment (7; 17; 27) is a radial refining segment.

11. A refining segment as claimed in any one of claims 1-9, characterized in that the refining segment (37) is annular and comprises two diametrically opposed cleaning members (40).

12. Refining apparatus for disintegrating and refining material containing lignocellulose in a refining gap between two opposing refining discs (4, 5) rotatable in relation to each other, characterized in that at least one rotatable refining disc is provided with at least one refining segment (7; 17; 27; 37) as claimed in any one of claims 1-11.
